(19) United States
(12) Patent Application Publication
(10) Pub. No.: US 2004/0042595 A1
(43) Pub. Date: Mar. 4, 2004

(54) Modification of delivered voice messages by the originator

(76) Inventors: Thomas C. Davis, Homer Glen, IL (US); Karla Rae Hunter, Naperville, IL (US); Ronald Bruce Martin, Carol Stream, IL (US); Shwu-Wei Yeh, Naperville, IL (US)

Correspondence Address: Docket Administrator (Room 3j-219), Lucent Technologies Inc., 101 Crawfords Corner Road, Holmdel, NJ, 07733-3030, US

(21) Appl. No.: 10/229,697

(22) Filed: Aug. 28, 2002

(51) Int. Cl. H04M 1/64

(52) U.S. Cl. 379/88.22

(57) ABSTRACT

The present invention relates to a method for an originator of a voice mail message stored on a voice mail system to modify the message after the session in which the message has ended. An originator initiates a session with a voice mail system, which queries the originator as to the intent of the session. If the session is to record a new message, the voice mail system accepts the message and a unique message identifier is assigned to the message. If the originator wishes to modify an existing voice mail message, the voice mail system requests the originator to supply the unique message identifier. After the message has been identified, the originator is given several options to modify the existing message.

### FIELD OF THE INVENTION

This invention relates generally to the field of communication systems, and more particularly to modification of voice mail messages previously delivered to a voice mail system.

### BACKGROUND OF THE INVENTION

Existing voice mail systems allow an originator of a voice mail message a number of options during the session during which the message is recorded. Originators can select among options such as re-recording the message, listening to the message recorded during the session, approving the message recorded during the session, setting the delivery time of the message, and creating a list of message recipients.

However, after the originator has ended a session in which the voice mail was recorded, the originator has no facility to modify the recorded message. If the originator needs to change the message due to needed changes in information in the message, the only option for the originator is to record a subsequent message containing the updated information. This is not an optimal solution as a recipient of the voice mail message may not listen to the second corrected message before the recipient acts on the incorrect information in the first message.

Therefore, a need exists for a method and apparatus that allows the originator of a voice mail message to modify a message previously recorded by the originator in the voice mail system. Further, a need exists for a method that allows the originator to specify which existing voice mail message is to be modified.

### BRIEF SUMMARY OF THE INVENTION

The present invention provides a method for an originator of a voice mail message stored on a voice mail system to modify the message after the session in which the message was recorded has ended. In an exemplary embodiment of the present invention, an originator initiates a session with a voice mail system. An originator preferably uses an originating user terminal during the original session, but can use the originating user terminal or any other user terminal to re-access the voice mail system. The voice mail system queries the originator as to the intent of the session. If the session is to record a new message, the voice mail system accepts the message and assigns a unique message identifier to the message so that the originator can modify the message at a later time.

In a further exemplary embodiment of the present invention, if upon querying the originator the voice mail system determines that the originator wishes to modify an existing message, the voice mail system requests the originator to supply the unique message identifier. After the message has been identified, the originator is given several options to modify the existing message. Example options include deletion of the entire message and editing specific parts of the message.

Advantageously, such an arrangement gives message originators the facility to modify messages stored in voice mail systems after the session in which the message had been recorded has ended.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for determining desired user action in accordance with an exemplary embodiment of the present invention during recording of a new message.

FIG. 3 depicts a flowchart of a method for accepting a new voice mail message in accordance with an exemplary embodiment of the present invention.

FIG. 4 depicts a flowchart of a method for modifying an existing voice mail message in accordance with an exemplary embodiment of the present invention.

### DETAILED DESCRIPTION OF THE INVENTION

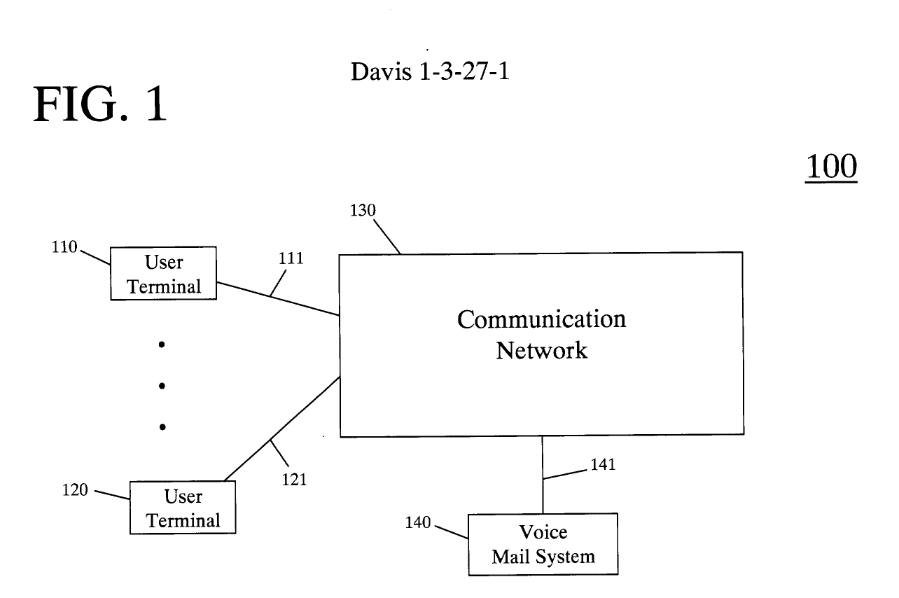

FIG. 1 depicts a communication system 100 in accordance with an exemplary embodiment of the present invention. Communication system 100 includes user terminals 110 and 120, communications network 130, and voice mail system 140. Communication network 130 comprises known functions necessary to operate and maintain communications between users of the network. Communication network 130 can be based on any well known technologies such as analog, digital, wireless, or wireline. For example, communication network 130 can be a Public Switched Telephone Network (PSTN), analog wireless (AMPS) or wireless digital (TDMA or CDMA).

User terminals 110 and 120 are coupled to communications network 130 via links 111 and 121, respectively, and provide communications among a plurality of user terminals such as 110 and 120. User terminals 110 and 120, as well as links 111, 121, and 141, can be based on any well-known technologies such as analog, digital, wireless, or wireline. It should be understood that communication system 100 can include a plurality of elements and user terminals. Only a single block of communication network elements 130, two user terminals 110 and 120, and single voice mail system are depicted in FIG. 1 for clarity.

In the embodiment depicted in FIG. 1, user terminal 110 and user terminal 120 are coupled to and communicating with communication network 130. It should be understood that in an actual network a plurality of user terminals are coupled to communication network 130. As depicted in FIG. 1 user terminal 110 is communicating with communication network 130 via link 111. User terminal 120 is communicating with communication network 130 via link 121. Links 111 and 121 can utilize the same protocol, or can be using different protocols to communicate with communication network 130.

In the embodiment depicted in FIG. 1, voice mail system 140 is coupled to and communicating with communication network 130 via link 141. It should be understood that in an actual network a plurality of voice mail systems are coupled to communication network 130.

In an exemplary embodiment of the present invention, voice mail system 140 receives a call request from a user terminal. The call request can originate from a terminal connected to communication network 130 or from any other network that can interface with communication network 130, such as an external PSTN. For this example, the call request is considered to arrive from user terminal 110.

Voice mail system 140 accepts the call and requests instructions from the originator using originating user terminal 110. The request can be sent a variety of ways, including but not limited to using inband analog signals and out-of-band messages.

If the instructions indicate that the originator using originating user terminal 110 will send a new voice mail message, voice mail system 140 records the incoming voice mail message. The presently recorded message can be erased and re-recorded at voice mail system 140.

When the message has been satisfactorily recorded, voice mail system prompts the originator using originating user terminal 110 to determine if a preferred identifier for the message is desired. The prompt can be sent in a variety of ways, including but not limited to inband analog signals and out-of-band messages. If a preferred identifier is not desired, voice mail system 140 assigns an identifier and transmits it to originating user terminal 110. The identifier can be transmitted in a variety of ways, including but not limited to inband analog signals and out-of-band messages.

If a preferred identifier is desired, voice mail system 140 receives the preferred identifier from originating user terminal 110. The preferred identifier can be received in a variety of ways, including but not limited to inband analog signals and out-of-band messages. After voice mail system 140 receives the preferred identifier, voice mail system 140 determines if the intended use of the preferred identifier would cause ambiguity or be in conflict with another preassigned use of the same identifier. For example, the preferred identifier may already be in use for an existing voice mail message from a different user. If no conflict is discovered, the preferred identifier is accepted and associated with the new voice mail message. If a conflict is discovered, voice mail system 140 sends a request to originating user terminal 110 to supply another preferred identifier, or voice mail system 140 can select the ID for the originator and send to originating user terminal 110.

If during the initial interaction with originating user terminal 110 voice mail system 140 determines that an existing message is to be modified, voice mail system 140 prompts the originator via originating user terminal 110 for the identifier of the message to be modified. Voice mail system 140 receives the unique identifier of the message to be modified. This interaction can be supported in a variety of ways, including but not limited to inband analog and out-of-band messages.

Voice mail system 140 prompts the originator for instructions concerning the modification to be made to the existing message. Any modification to data in a stored medium can be supported by the present invention. Two examples are modification of the entire message and modification of a segment of the message. In an exemplary embodiment of the present invention, the segment to be modified could be identified by the originator sending a signal at the beginning and end of the segment to be modified while voice mail system 140 plays the existing message. Voice mail system 140 then performs the modification requested.

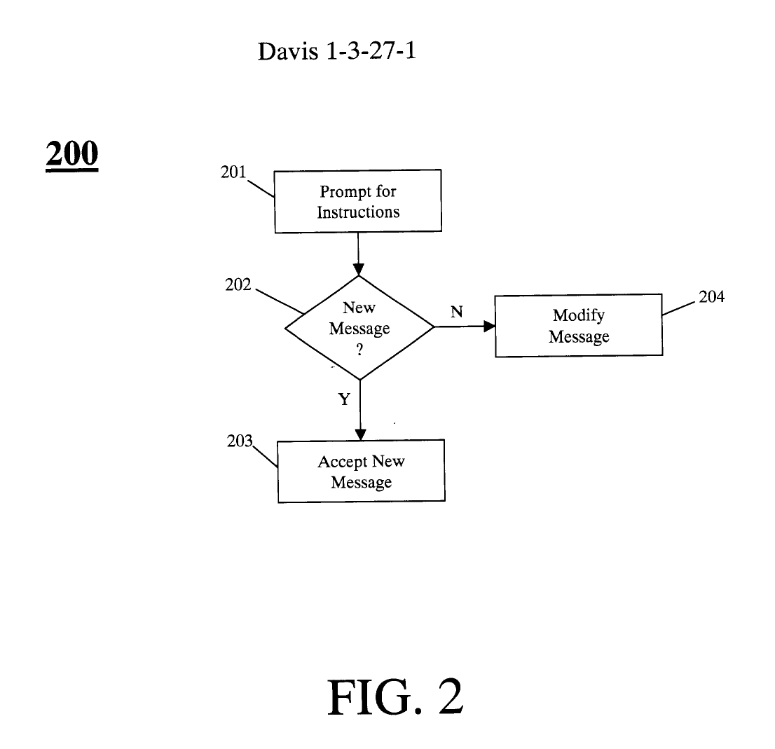

FIG. 2 depicts a flowchart (200) of a method for determining desired user action during recording of a new message in accordance with an exemplary embodiment of the present invention.

Voice mail system 140 prompts (201) the user using originating user terminal 110 for instructions. The prompting can be done in a variety of ways, including but not limited to an analog inband voice prompt or out-of-band message.

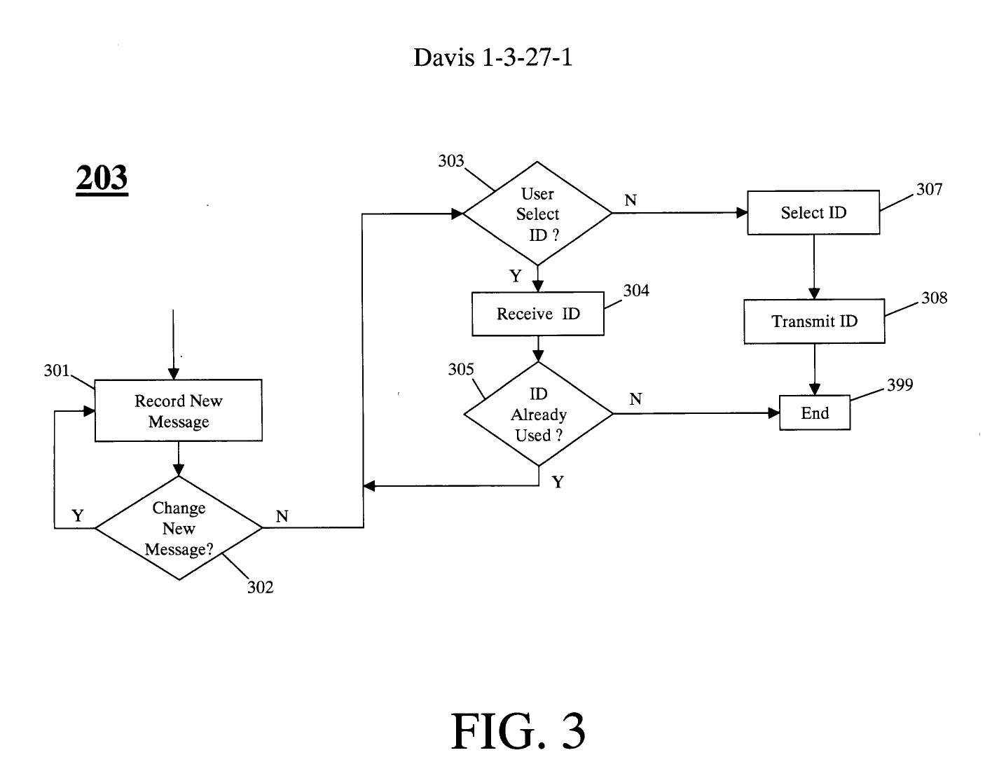

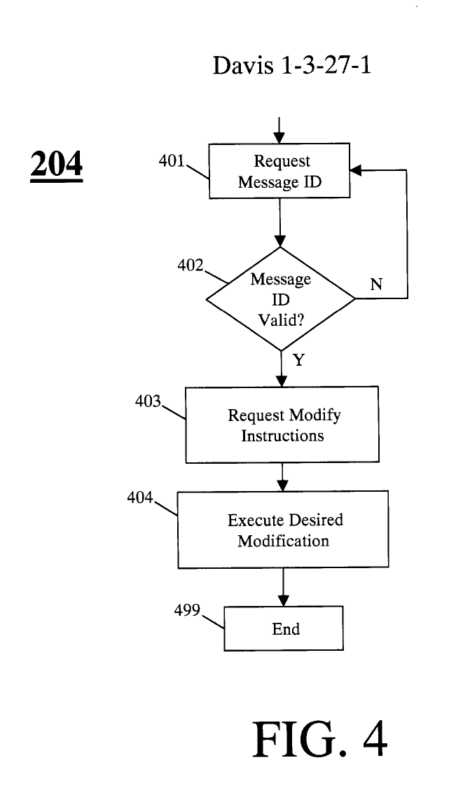

Voice mail system 140 determines (202) based on the instructions from originating user terminal 110 if the originator wants to leave a new voice mail message. The decision can be made in a variety of ways, including but not limited to Automatic Speech Recognition (ASR) techniques, touch tone receivers, and by processing an out-of-band message. If voice mail system 140 determines that originator wants to leave a new voice mail message, voice mail system 140 accepts (203) the new message, as described in more detail in FIG. 3 below. If voice mail system 140 determines at step 202 that the originator does not want to leave a new voice mail message, voice mail message 140 modifies (204) an existing voice mail message, as described in more detail in FIG. 4 below.

Turning now to FIG. 3, FIG. 3 depicts a flowchart 203 of a method for accepting a new voice mail message in accordance with an exemplary embodiment of the present invention.

Voice mail system 140 records (301) a new voice mail message. This preferably occurs after prompting the originator to determine their desired action. The message is then stored at the voice mail system, although the originator using originating user terminal 110 still exercises some control over the stored voice mail message.

Voice mail system 140 determines (302) if the presently recorded message is to be changed. This decision can be caused by an independent signal from originating user terminal 110 or via interactions between originating user terminal 110 and voice mail system 140. For example, voice mail system 140 can prompt the originator using originating user terminal 110 for instructions on whether the originator wishes to change the message, delete the message, or deliver the message to the voice mailbox of the intended recipient. The interactions can be supported in a variety of ways, including but not limited to inband analog and out-of-band message.

If the presently recorded message is to be changed, voice mail system 140 records (301) a new message. Voice mail system 140 preferably deletes the previously recorded voice mail message.

If the presently recorded message is not to be changed during this session, voice mail system 140 determines (303) if a preferred identifier is desired for the presently recorded message. This decision can be caused by an independent signal from the originator using originating user terminal 110 or via interactions between originating user terminal 110 and voice mail system 140. The interactions can be supported in a variety of ways, including but not limited to inband analog and out-of-band message.

If a preferred identifier is not required, voice mail system 140 selects (307)an identifier. This selection can be accomplished in a variety of ways, including but not limited to the use of a random number generator or via a sequential distribution of identifiers. After the identifier has been generated, the identifier is checked for conflict with existing identifiers. If a conflict is detected, a new identifier is generated. If no conflict is detected, the new identifier is utilized.

Voice mail system 140 transmits (308) the selected identifier to originating user terminal 110. The transmission of the identifier can be supported in a variety of ways, including but not limited to inband analog an out-of-band message.

The session now ends (399). It should be understood that originating user terminal 110 may desire to send a second voice mail message to the recipient. In this case, the process would begin again at step 301.

If a preferred identifier from the originator using originating user terminal 110 is desired as determined at step 303, voice mail system 140 receives (304) the preferred identifier form originating user terminal 110. The reception of the identifier can be supported in a variety of ways, including but not limited to inband analog an out-of-band message.

After reception of the preferred identifier, voice mail system 140 determines (305) if the preferred identifier is in conflict with an identifier already assigned. If not, voice mail system 140 sends an acknowledgement to originating user terminal 110 indicating that the preferred identifier has been accepted, and the session ends (399).

If voice mail system 140 detects a conflict between the selected identifier and an existing identifier, the processing returns to step 303. In this manner, the originator using originating user terminal 110 can decide to choose an alternate message identifier, or can allow voice mal system 140 to choose an identifier for the stored voice mail message.

FIG. 4 depicts a flowchart (204) of a method for modifying an existing voice mail message in accordance with an exemplary embodiment of the present invention.

Voice mail system 140 requests (401) the voice mail message identifier of the message to be modified. This prompting can be supported in a variety of ways, including but not limited to inband analog and out-of-band message.

Using the received identifier, voice mail system 140 determines (402) if the message identifier is a valid message identifier. This can be accomplished through any known schemes for indexing to information in a data base. For example, the identifier may actually be the address for the memory location of the beginning of the message to be modified.

If voice mail system 140 determines that the message identifier given is invalid, i.e. is not associated with a currently-stored voice mail message, voice mail system 140 returns to step 401 and requests (401) a message ID for the stored voice mail message. This process continues until a valid message ID is received from the originator. The process can also be terminated by allowing the originator to choose to end the process, such as by pressing a predetermined key sequence or by hanging up, via a timeout by voice mail system 140, or by a predetermined number of failed attempts to enter a valid message identifier.

Once a valid message identifier has been entered, voice mail system 140 requests (403) instructions as to the type of modification to be made on the existing message. Any modification to data in a stored medium currently in the art can be supported by the current invention. Two examples are modification of the entire message and modification of a segment of the message. In an exemplary embodiment of the present invention, the segment to be modified could be identified by the originating user terminal sending a signal at the beginning and end of the segment to be modified while voice mail system 140 plays the existing message. Voice mail system 140 then will replace the marked message segment with a newly recorded message from the originator.

Voice mail system 140 executes (404) the desired modification. This modification can be accomplished in a variety of ways, including but not limited to over writing a segment of analog recording and replacing a block of digital data in memory. The session then ends (499).

The present invention thereby provides a method for modifying a message that has been stored in a voice message system. By using the present invention, the originator of a voice message can update out-of-date information in a stored voice mail message. Currently, the person receiving the messages would have to listen to the updated message to receive the correct message. By allowing an originator to modify a voice mail message stored in a previous voice mail session, more accurate information can be deposited in the voice mail account of a voice mail user.

While this invention has been described in terms of certain examples thereof, it is not intended that it be limited to the above description, but rather only to the extent set forth in the claims that follow.

We claim:

1. A method for providing control of voice messages by an originating user terminal after message delivery, the method comprising the steps of:
accepting a call request at a network voice mail system from an originating user terminal;
determining that the originating user terminal wishes to leave a new message;
accepting a new voice message from the originating user terminal at the network voice mail system;
associating a unique identifier to the new voice message; and
informing the originating user terminal of the unique identifier.

2. A method for providing control of voice messages by an originating user terminal after message delivery in accordance with claim 1, the method further comprising the step of, prior to determining that the originating user terminal wishes to leave a new message, requesting instructions from the originating user terminal.

3. A method for providing control of voice messages by an originating user terminal after message delivery in accordance with claim 1, wherein the step of determining that the originating user terminal wishes to leave a new message comprises accepting instructions from the originating user terminal.

4. A method for providing control of voice messages by an originating user terminal after message delivery in accordance with claim 1, further comprising the step of allowing the originating user terminal to modify the new voice message.

5. A method for providing control of voice messages by an originating user terminal after message delivery in accordance with claim 1, wherein the step of associating a unique identifier to the new voice message comprises requesting a preferred identifier from the originating user terminal.

6. A method for providing control of voice messages by an originating user terminal after message delivery in accordance with claim 5, further comprising the step of receiving the preferred identifier from the originating user terminal.

7. A method for providing control of voice messages by an originating user terminal after message delivery in accordance with claim 6, the method further comprising the step of determining if the requested identifier has already been assigned.

8. A method for providing control of voice messages by an originating user terminal after message delivery in accordance with claim 7, the method further comprising, if the requested identifier has already been assigned, requesting a different preferred identifier from the originating user terminal.

9. A method for providing control of a voice mail message by an originator of the voice mail message after message delivery, the method comprising the steps of:
accepting a call request at a network voice mail system from an originator;
determining that the originator wishes to modify an existing voice mail message, the existing voice mail message being originally recorded by the originator;
determining the existing voice mail message; and
allowing the originator to modify the existing voice mail message.

10. A method for providing control of a voice mail message by an originator of the voice mail message after message delivery in accordance with claim 9, wherein the step of determining that the originator wishes to modify an existing voice mail message comprises requesting instructions from the originator.

11. A method for providing control of a voice mail message by an originator of the voice mail message after message delivery in accordance with claim 10, wherein the step of determining that the originator wishes to modify an existing voice mail message comprises accepting instructions from the originator.

12. A method for providing control of a voice mail message by an originator of the voice mail message after message delivery in accordance with claim 9, wherein the step of determining the existing voice mail message comprises requesting the unique identifier of the existing voice mail message from the originator.

13. A method for providing control of a voice mail message by an originator of the voice mail message after message delivery in accordance with claim 9, wherein the step of determining the existing voice mail message comprises accepting the unique identifier of the existing voice mail message from the originator.
